(19) United States
(12) Patent Application Publication
(10) Pub. No.: US 2014/0059919 A1
(43) Pub. Date: Mar. 6, 2014

(54) Rodent bait station

(71) Applicant: Joseph C. Pupello, Tampa, FL (US)

(72) Inventor: Joseph C. Pupello, Tampa, FL (US)

(21) Appl. No.: 13/573,240

(22) Filed: Sep. 4, 2012

(51) Int. Cl. A01M 25/00

(52) U.S. Cl. 43/131

(57) ABSTRACT

A rodent bait station to safely deploy poison bait to control a rodent population comprising an enclosure including a bait cavity to house a bait holder to secure the poison bait within the bait cavity having a first rodent access opening and a second rodent access opening each including a transparent barrier to partially block or close the openings for rodents to enter and exit the bait cavity and a first tunnel and a second tunnel to provide passage to and from the surrounding environs through the first rodent access opening and the second rodent access respectively into and out of the bait cavity.

### BACKGROUND OF THE INVENTION

1. Field of the Invention

A rodent bait station to safely deploy poison bait to control a rodent population.

2. Description of the Prior Art

In order to control a rodent population by the use of poison bait rodents must have access to the bait while preventing access by pets and children. The bait should thus be contained in a tamper proof as well as weather resistant enclosure. This can be accomplished by limiting the entry/exit dimensions, the use of baffles or by incorporating maze-like pathways to the bait. Some bait stations that require replenishment of the bait are difficult to be disassembled or opened for refilling.

A number of examples of the prior art are described below.

U.S. Pat. No. 3,965,609 discloses a rodent baiting system including a modular unit assembled to form a feeding station through which rodents may pass and consume poisonous bait therein. The modular units may be assembled for placement along a wall or corner of an interior room or space, while being inaccessible to children and domestic animals. The assembled modules form a passage for the rodents, with feed and water alongside of the passage.

U.S. Pat. No. 4,619,071 shows a rodent poison bait station including a rectangular housing forming an enclosure cooperating with bait retaining panels to form a pair of bait containing compartments within the housing laterally of a pair of generally axially aligned rodent entrance holes. The bait retainers are offset from the entrance holes and maintained spaced-apart by bait confining rails extending therebetween which prevent bait being moved toward the entrance holes from the bait compartments. Access to the bait compartments by the rodent is achieved by rodent destruction of a grid covering a window in a panel forming a part of the bait compartment.

U.S. Pat. No. 5,448,852 relates to a rodenticide dispenser comprising a base with a floor from which exterior sidewalls extend upwardly. A lid is joined to the base by an integral hinge. The lid is pivotal about the hinge to selectively cover and uncover the base. A passageway for pests, in particular rodents such as rats, is formed within the interior volume of the covered base by two converging barriers, the ends of which are spaced from one another to define a rodent feeding trough. Each barrier is comprised of two segments: a base barrier segment which is integrally formed with the base and extends upwardly from the base floor a distance less than the height of the base sidewalls, and a lid barrier segment which is integrally formed with the lid and which protrudes from the lid. The lid barrier segment is aligned with the base barrier segment when the lid covers the base to define a barrier across a portion of the base to block the passage of pests through the barrier. Pairs of prongs extend upwardly from the base barrier segment in spaced opposed relation, such that the lid barrier segment when it covers the base is engaged between the prongs to thereby restrict displacement of the lid barrier segment. Two spaced pockets are formed within the base which have ledges which receive lid protrusions. The locks so formed are inaccessible to tampering, yet are conveniently opened by those provided with a two-tabbed key.

U.S. Pat. No. 6,082,042 shows a bait station for containing rat poison comprising a housing; at least one opening in the housing for a rat to enter; and a bait position in the housing for locating poisoned bait. A divider is provided between the bait position and each opening to prevent direct access to the bait from the opening, for example by a child. However, there are at least two different routes from the bait position leading to openings. The bait station may include a hinged lid with locking means to prevent tampering with the bait.

US 2012/0036763 discloses a pest control device including a bottom, two side walls, two end walls with holes therethrough to permit an animal to enter, and a lid, with a bait holder inside the trap, which may optionally be raised off of the floor of the trap and magnets positioned near the top edge of at least two of the walls to secure the trap to a dumpster, thereby holding the lid in the closed position when the trap is secured to the dumpster to prevent access to the bait other than through the holes in the end walls. On the bottom of the device a bait holder is provided, to secure bait in the pest control device. The term “bait” as used herein is intended to include poisonous bait. The bait holder may preferably comprise, for example, spikes extending upwardly from the bottom of the device such that bait can be secured on the spikes. Additionally, the bait holder may optionally be raised.

Other examples of the prior art may be found in U.S. Pat. No. 2,710,485; U.S. Pat. No. 4,364,194; U.S. Pat. No. 4,375,732; U.S. Pat. No. 4,550,525; U.S. Pat. No. 4,453,337; U.S. Pat. No. 4,835,902; U.S. Pat. No. 5,022,180; U.S. Pat. No. 5,040,327 and U.S. Pat. No. 5,446,992.

While some of the prior art may contain some similarities relating to the present invention, none of them teach, suggest or include all of the advantages and unique features of the invention disclosed hereafter.

### SUMMARY OF THE INVENTION

The present invention relates to a rodent bait station to safely deploy poison bait to control a rodent population.

The rodent bait station comprises an enclosure including a top wall and bottom wall, a pair of side walls, a front wall and a removable back wall to cooperatively form a bait chamber or cavity to house a bait holder therein.

A first rodent access opening and a second rodent access opening are formed in one of the side walls and the front wall for rodents to enter and exit the bait chamber or cavity to feed on the poison bait secured to the bait holder.

A barrier partially obstructs the lower portion of the rodent access openings to prevent removal of the bait from the bait chamber or cavity.

A first tunnel and a second tunnel provide passage to and from the surrounding environs to the interior of the bait cavity through the first rodent access opening and the second rodent access opening respectively.

The centerlines of the first rodent access opening and first tunnel are disposed at an angle to the centerlines of the second rodent access opening and second alternative tunnel.

The bait holder may comprise a spike or member to receive the poison bait thereon.

Alternately the first rodent access opening and first tunnel may be concentrically aligned with the second rodent access opening.

In use, poison bait is securely placed or positioned on the spike or member of the bait holder. The back wall is then secured to the side walls. The assembled and baited rodent bait station is then placed along a route known to or likely to be traveled by rodents. Since entry to the bait chamber or cavity is through either tunnel, the rodents are more readily attracted to the poison bait.

The invention accordingly comprises the features of construction, combination of elements, and arrangement of parts which will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1 is an exploded perspective view of the rodent bait station of the present invention.

FIG. 2 is a top view of the rodent bait station of the present invention.

FIG. 3 is a back view of the rodent bait station of the present invention.>

FIG. 4 is an exploded cross-sectional top view of the rodent bait station of the present invention.

FIG. 5 is a cross-sectional back view of the rodent bait station of the present invention.

FIG. 6 is a side view of the back wall and bait holder of the rodent bait station of the present invention.

FIG. 7 is a back view of an alternate embodiment of the rodent bait station of the present invention.

Similar reference characters refer to similar parts throughout the several views of the drawings.

### DETAILED DESCRIPTION OF THE PREFERRED EMBODIMENT

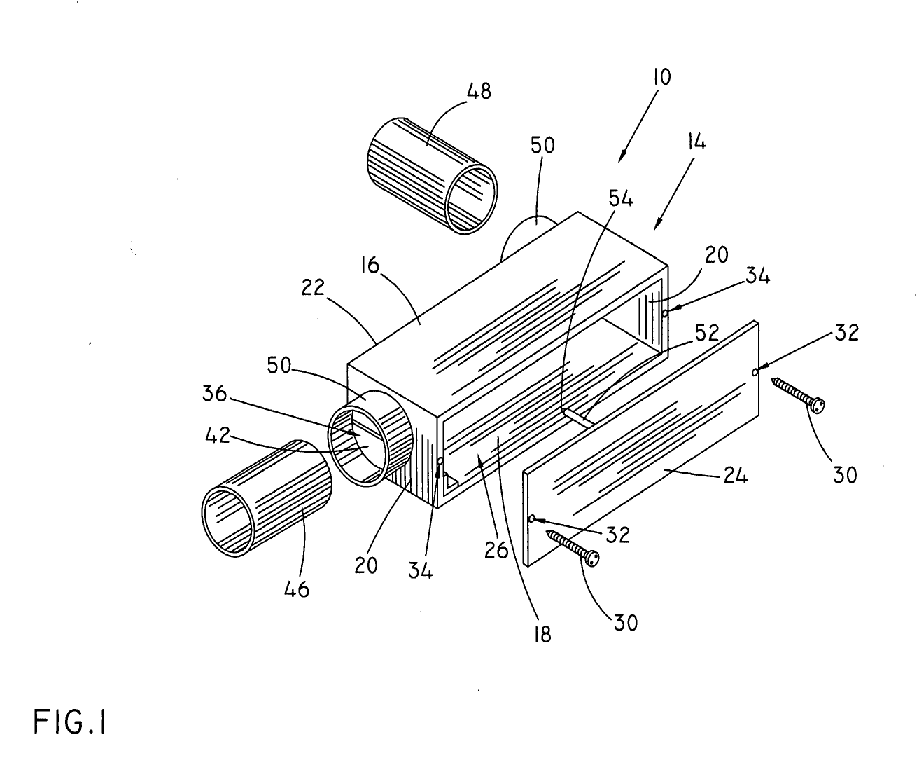

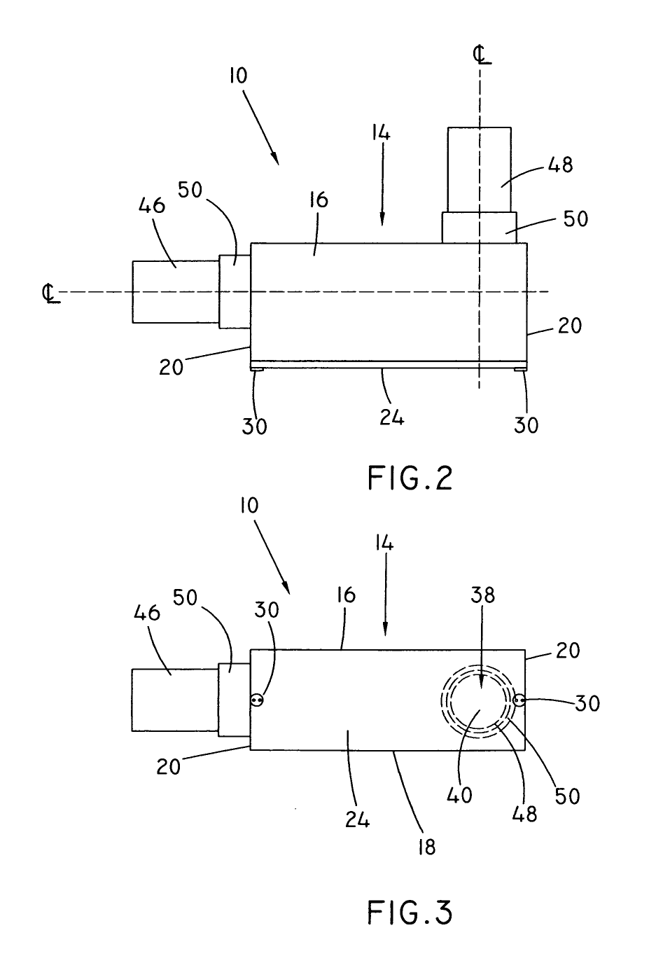

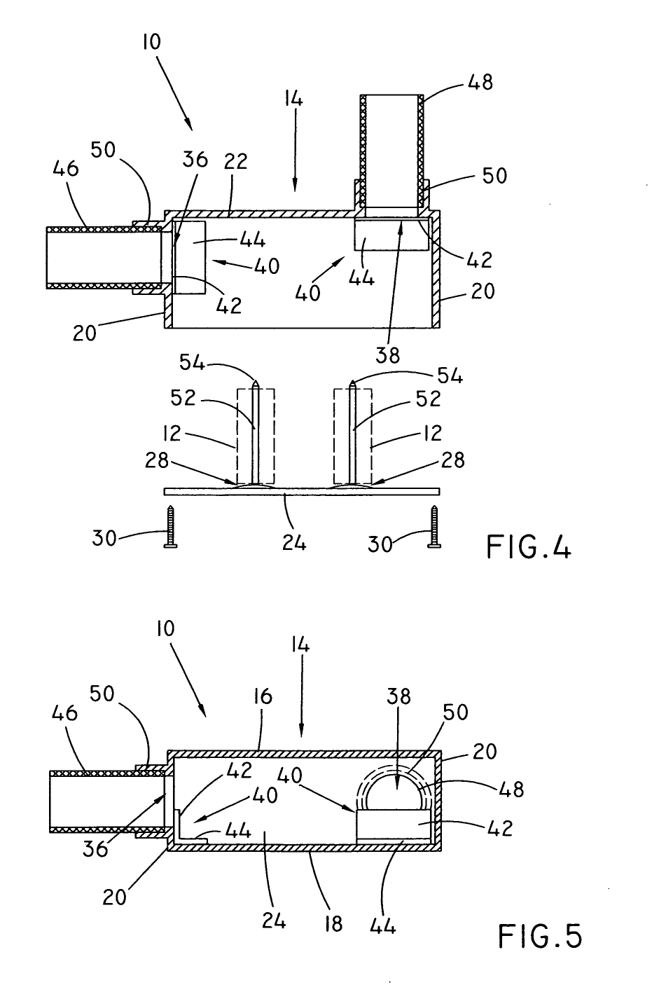

As shown in FIGS. 1 through 5, the present invention relates to a rodent bait station generally indicated as 10 to safely deploy poison bait 12 to control the rodent population.

The rodent bait station 10 comprises an enclosure generally indicated as 14 including a top wall and bottom wall indicated as 16 and 18 respectively, a pair of side walls each indicated as 20, a front wall 22 and a removable back wall 24 to cooperatively form a bait chamber 26 to house a bait holder generally indicated as 28 therein when the removable back wall 24 is attached or mounted to the side walls 20 by externally threaded fasteners 30 extending through a corresponding hole 32 formed in each end portion of the removable back wall 24 and into a corresponding recess 34 formed in the rear edge of each side wall 20.

A first rodent access opening 36 and a second rodent access opening 38 are formed in one of the side walls 20 and the front wall 22 respectively for rodents to enter and exit the bait cavity 26 to feed on the poison bait 12 secured to the bait holder 28.

A transparent barrier 40 comprising an L-shaped member including a substantially vertical leg 42 obstructing the lower portion of the corresponding rodent access opening 36 or 38 to prevent removal of the bait 12 from the bait cavity 26 and a substantially horizontal leg 44 to secure the transparent barrier 40 to the bottom wall 18. In addition, the transparent barrier 40 prevents water from invading the bait cavity under normal weather conditions when the rodent bait station 10 is used outdoors.

A first substantially cylindrical tunnel 46 and a second substantially cylindrical tunnel 48 provide passage to and from the surrounding environs to the interior of the bait cavity 14 through the first rodent access opening 36 and the second rodent access opening 38 respectively.

The first tunnel 46 and the second tunnel 48 are removably coupled to the side wall 20 containing the first rodent access opening 36 and the front wall 22 of the enclosure 14 by a corresponding substantially cylindrical coupler member 50 extending from the side wall 20 and the front wall 22 respectively.

The centerlines CL of the first rodent access opening 36, corresponding substantially cylindrical coupler member 50 and first substantially cylindrical tunnel 46 are disposed at an angle such as 90 degrees to the centerlines CL of the second rodent access opening 38, corresponding substantially cylindrical coupler member 50 and second substantially cylindrical tunnel 48.

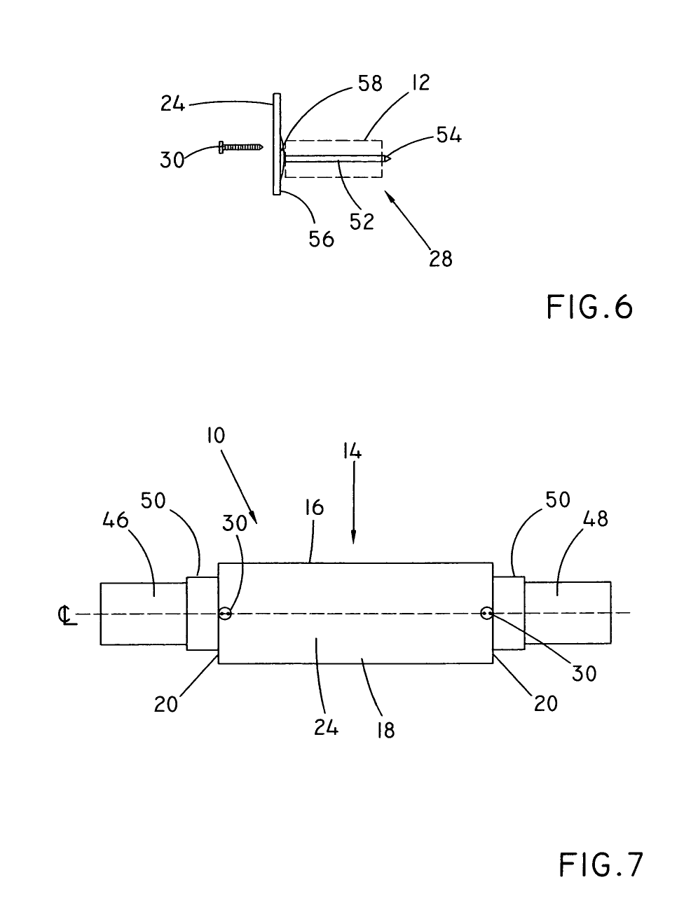

As shown in FIG. 6, the bait holder 28 comprises an elongated spike or member 52 having a pointed or sharp end portion 54 to receive the poison bait 12 thereon flexibly attached to the inner surface 56 of the removable back wall 24 by a rubber or malleable base 58.

FIG. 7 shows an alternate embodiment of the rodent bait station 10 similarly structured to that of the rodent bait station of FIGS. 1 through 5 except that the first rodent access opening 36, corresponding substantially cylindrical coupler member 50 and first substantially cylindrical tunnel 46 are concentrically aligned with the second rodent access opening 38, corresponding substantially cylindrical coupler member 50 and second substantially cylindrical tunnel 48 along centerline CL. Accordingly similar structured parts or elements are similarly designated.

In use, poison bait 12 is securely placed or positioned on the elongated spike or member 52 of the bait holder 28. The back wall 24 is then secured to the side walls 20 with fasteners 30. The assembled and baited rodent bait station 10 is then placed along a route known to or likely to be traveled by rodents. Since entry to the bait chamber 26 is through either substantially cylindrical tunnel 46 or 48, the rodents are more readily attracted to the poison bait 12. Furthermore, the angularly disposed or configuration of the substantially cylindrical tunnels 46 and 48 relative to each other permits placement of the rodent bait station 10 into corners of structures traveled by rodents.

It will thus be seen that the objects set forth above, among those made apparent from the preceding description are efficiently attained and since certain changes may be made in the above construction without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Now that the invention has been described,

What is claimed is:

1. A rodent bait station to safely deploy poison bait to control a rodent population comprising an enclosure including a bait cavity to house a bait holder to secure the poison bait within said bait cavity having a first rodent access opening and a second rodent access opening each including a barrier to partially block or close said openings for rodents to enter and exit said bait cavity.

2. The rodent bait station of claim 1 further including a first tunnel and a second tunnel to provide passage to and from the surrounding environs to the interior of said bait cavity through said first rodent access opening and said second rodent access opening respectively.

3. The rodent bait station of claim 2 wherein said first tunnel and said second tunnel are each substantially cylindrical in shape.

4. The rodent bait station of claim 3 wherein said first tunnel and said second tunnel are removably coupled to said corresponding side wall containing said first rodent access opening and said front wall containing said second rodent access opening by a corresponding substantially cylindrical coupler member extending from said corresponding side wall and said front wall respectively.

5. The rodent bait station of claim 4 wherein the centerlines of said first rodent access opening, corresponding substantially cylindrical coupler member and said first substantially cylindrical tunnel are disposed at an angle relative to the centerlines of said second rodent access opening, corresponding substantially cylindrical coupler member and said second substantially cylindrical tunnel.

6. The rodent bait station of claim 3 wherein each said barrier is transparent.

7. The rodent bait station of claim 3 wherein each said barrier comprises a transparent barrier comprising an L-shaped member including a substantially vertical leg obstructing the lower portion of the corresponding rodent access opening to prevent removal of the bait from said bait cavity and a substantially horizontal leg to secure said transparent barrier to said bottom wall.

8. The rodent bait station of claim 2 wherein said bait holder comprises an elongated member to receive the poison bait thereon.

9. The rodent bait station of claim 8 wherein said elongated member comprises a spike having a pointed end portion to receive the bait thereon.

10. The rodent bait station of claim 9 wherein said spike is flexibly attached to the inner surface of said removable back wall.
